(19) United States
(12) Patent Application Publication
(10) Pub. No.: US 2008/0084157 A1
(43) Pub. Date: Apr. 10, 2008

(54) LIGHT EMITTING DEVICE

(75) Inventors: Hisaya TAKAHASHI, Kanagawa (JP); Atsushi NAMBA, Tokyo (JP); Fujio MATSUI, Tokyo (JP)

Correspondence Address: HAYNES AND BOONE, LLP, 901 Main Street, Suite 3100, Dallas, TX, 75202, US

(73) Assignee: FUJI JUKOGYO KABUSHIKI KAISHA, Tokyo (JP)

(21) Appl. No.: 11/867,169

(22) Filed: Oct. 4, 2007

(30) Foreign Application Priority Data
Oct. 4, 2006 (JP) 2006-273382

(51) Int. Cl. H01J 1/62

(52) U.S. Cl. 313/496

(57) ABSTRACT

The object of the invention is to radiate light towards the outside, improve the luminous efficiency and obtain a high-intensity externally radiated light without hindering the light from being emitted on the entire surface of a phosphor layer. A glass substrate 2, that forms a light projection window, and a glass substrate 3, that forms a base bottom surface, are oppositely disposed at a predetermined interval to form a vacuum chamber, an anode electrode 5 is provided at a region at the center of the glass substrate 3, and a cathode electrode 6 is provided at a region on both sides of the anode electrode 5. A phosphor layer 7 is formed as a film on the anode electrode 5, an electron emission source 8 is formed as a film on the cathode electrode 6, and a gate electrode 9 is arranged above the electron emission source 8. An electric field is applied to the electron emission source 8 to emit an electron beam and make the electron beam uniformly fall onto the phosphor layer 7 in a parabolic shape to excite the phosphor layer 7 and emit light. Because only a vacuum space lies between the phosphor layer 7 and the glass 2, the intense light emitted by the excitation surface of the phosphor layer 7 is emitted from the glass substrate 2 towards the outside without any interference and suppresses electric power consumption while significantly increasing the quantity of light.

### CROSS REFERENCE TO RELATED APPLICATIONS

This application claims priority under 35 U.S.C. 119 based upon Japanese Patent Application Serial No. 2006-273382, filed on Oct. 4, 2006. The entire disclosures of the aforesaid applications are incorporated herein by reference.

### FIELD OF THE INVENTION

The present invention relates to a device for emitting light with a phosphor excited by electrons emitted from an electron emission source.

### BACKGROUND OF THE INVENTION

As opposed to conventional light-emitting devices such as incandescent light bulbs and fluorescent light tubes, electron beam-excited light-emitting devices have been recently developed for illumination or image display, using light-emitting phosphors (fluorescent materials) excited by high speed bombardment of electrons released from a electron emission source in a vacuum chamber.

As disclosed in Japanese Unexamined Patent Application Publication No. 2004-207066 (hereafter referred as patent reference 1), in the structure generally used for this type of light emitting device, the light is emitted from a phosphor layer on a glass substrate and transmitted through the glass substrate on the rear of the phosphor layer radiating towards the outside. In this structure, however, the luminous efficiency is compromised since the light is emitted the most on the electron-irradiated surface of the phosphor layer and wasted within the vacuum chamber.

Because of this, in order to increase the brightness of the electron beam-excited display devices, there is known a technique for forming a metal back layer by, for example, depositing aluminum on the electron-irradiated surface of the phosphor layer. This metal back layer has an objective of not only increasing the brightness by reflecting the light from the phosphor emitted toward inside of the device to the outer surface (display or illuminating side) of the device with the specular reflection, but also protects the phosphor from damages by applying a predetermined electric potential to the phosphor surface, wherein damage occurs due to the electron charge on the phosphor surface and by the collision of negative ions generated within the device against the phosphor surface as disclosed in, for example, Japanese Unexamined Patent Application Publication No. 2000-251797 (hereafter referred as patent reference 2).

In order to stabilize the display quality of a device for forming and displaying images using light-emitting phosphor film, the technology of patent reference 2 uses a technique for dividing the metal back, disposed on the inner surface of the phosphor film, into a plurality of portions, and coating the gaps of the plurality of divisions with a conductive material to prevent creeping discharges on the gap portion surface caused by abnormal electric discharges occurring in vacuum.

However, the technique for using the metal back to improve the luminous efficiency of the device results in a reduction of the phosphor excitation efficiency due to an accelerated energy loss of the electron beam when it enters the metal back layer. In particular, when utilizing an illumination device, this decrease in phosphor excitation efficiency associated with the loss of the acceleration energy cannot be ignored and hinders the fundamental improvement of the luminous efficiency.

Therefore, Japanese Unexamined Patent Application Publication No. H10-12164 (hereafter referred as patent reference 3), which relates to a thin type display device, in which an emitter electrode line having emitter tips in a pixel area, a negative plate with a gate arranged such that it intersects with the emitter electrode line in a pixel area, and a positive plate having a phosphor layer are oppositely placed at a fixed interval discloses that at least the pixel constituting area of the emitter electrode line and gate electrode line is formed by a transparent conductive film and then the light emitted from the phosphor layer is observed through this transparent conductive film, namely, a technology to views light emitted from the phosphor from the surface side of the phosphor layer.

Although the technology disclosed in patent reference 3 can obtain a high-intensity display when using it as a display device by means of viewing the light emitted from a phosphor from the phosphor surface side, when taking illumination applications into consideration, illumination light is obtained through a negative plate opposing the phosphor layer. In other words, the light emitted towards the outside from the gap between the emitter tip on the negative plate and the lower metal conductive layer of the emitter electrode line and the gate electrode line is used as illumination light resulting in the light radiated from the phosphor being attenuated or scattered making it impossible to effectively utilize the light emitted on the entire surface of the phosphor layer.

### SUMMARY OF THE INVENTION

Considering the above situation, the purpose of the present invention is to provide a light-emitting device that allows light being emitted on the entire surface of a phosphor layer to radiate towards the outside, without hindrance, thus improving the luminous efficiency and obtaining a high-intensity externally radiated light.

In order to achieve the above object, there is provided a light emitting device according to the present invention for emitting light toward the outside with a phosphor excited by an electron beam emitted from a electron emission source arranged inside a vacuum chamber,

the light emitting device comprising:

an anode electrode arranged opposite a transparent base material that forms a light projection window of the vacuum chamber,

a phosphor layer arranged on a surface of the anode electrode facing the transparent base material,

a cathode electrode arranged outside the light path towards the light projection window of the light emitted by the phosphor layer,

an electron emission source arranged on the cathode electrode, and

a gate electrode that deflects and controls the electron beam emitted from the electron emission source to irradiate the surface of the phosphor layer facing the transparent base material.

The light-emitting device according to the present invention is capable of radiating, without hindrance, the light emitted on the entire surface of a phosphor layer towards the outside to improve the luminous efficiency and obtain a high-intensity externally radiated light.

### BRIEF DESCRIPTION OF THE DRAWINGS

FIG. 1 is a basic block diagram of a light-emitting device;

FIG. 2 is a plan view showing the configuration of an electron emission source and a phosphor layer seen from the cross section line A-A of FIG. 1;

FIG. 3 is a descriptive view showing the relationship between a gate electrode and a cathode mask;

FIG. 4 is a plan view showing a second configuration example of an electron emission source and a phosphor layer;

FIG. 5 is a plan view showing a third configuration example of an electron emission source and a phosphor layer.

### DETAILED DESCRIPTION OF THE INVENTION

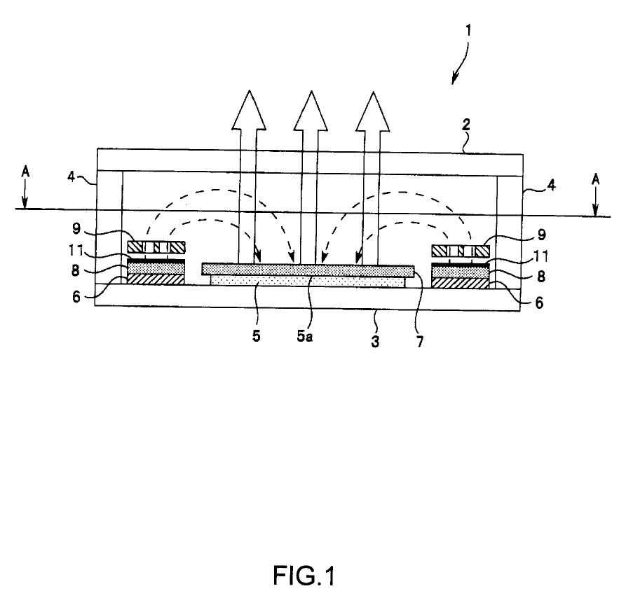

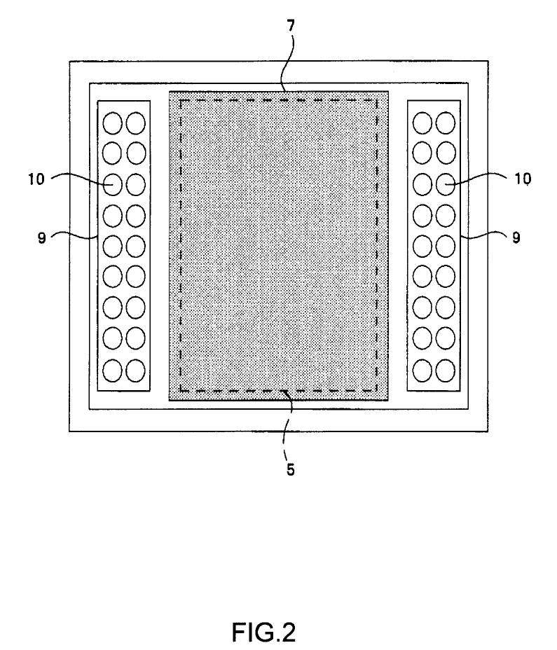

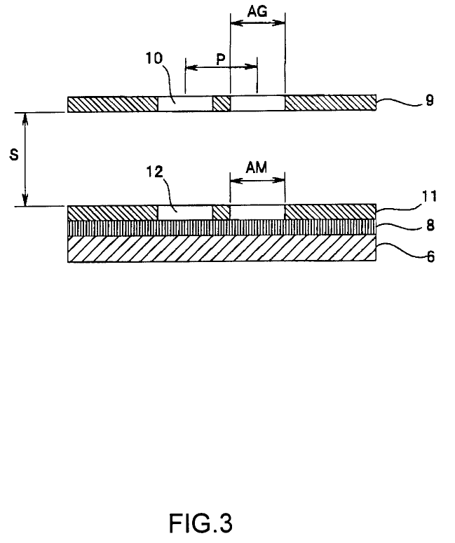

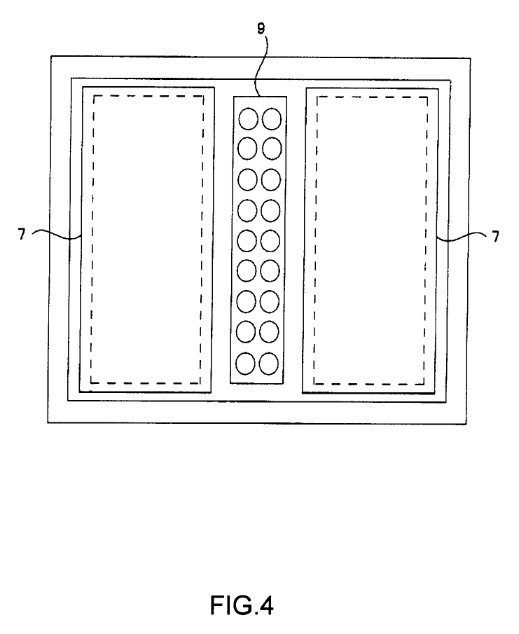

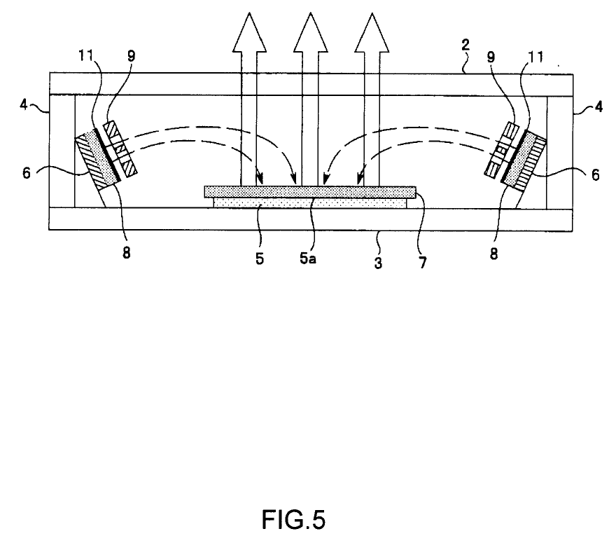

In the following, preferred embodiments of the present invention will be described in detail with reference to the accompanying diagrams. FIG. 1 to FIG. 5 relate to one embodiment of the present invention, wherein FIG. 1 is a basic block diagram of a light-emitting device; FIG. 2 is a plan view showing the configuration of an electron emission source and a phosphor layer seen from the cross section line A-A of FIG. 1; FIG. 3 is a descriptive view showing the relationship between a gate electrode and a cathode mask; FIG. 4 is a plan view showing a second configuration example of an electron emission source and a phosphor layer; and FIG. 5 is a plan view showing a third configuration example of an electron emission source and a phosphor layer.

In FIG. 1, reference numeral 1 indicates a light-emitting device which is used as, for example, a planar illumination lamp that radiates illumination light in a flat shape. This light-emitting device 1 is formed as a thin type box-shaped vessel with a glass substrate 2, that functions as a transparent base material forming an light projection window that projects light towards the outside, and a glass substrate 3, that functions as an insulation base material on the bottom of the base, oppositely disposed at a predetermined interval through a framing member 4. The inside of the vessel is evacuated to form a vacuum state and sealed by the framing member 4 comprised by a frit glass, for example.

Conductive patterns are separately formed into films in predetermined shapes on the glass substrate 3 that forms the bottom side of the vacuum chamber. Vapor deposition or sputtering method is used to deposit, for example, ITO, aluminum, or nickel, and a film formed by applying, drying, and sintering a silver paste material. An anode electrode 5 and a cathode electrode 6 are formed by these conductive patterns. As shown in FIG. 2, in this embodiment the anode electrode 5 is formed in a rectangular shaped region at the approximate center of the glass substrate 3 and the cathode electrode 6 is formed as a rectangular shaped region arranged on both sides of the anode electrode 5.

A phosphor layer 7 that is excited and emits light by means of electron beam irradiation is formed on the anode electrode 5 in a somewhat wider region or identical to the anode electrode 5 by, for example, a screen printing method, an inkjet method, a photographic method, a precipitation method, or an electro-deposition method. The phosphor layer 7 is arranged opposite to the glass substrate 2 that forms a light projection window, having only the vacuum space in-between, and the surface opposite to this glass substrate 2 forms the excitation surface that is excited and emits light by means of electron beam irradiation. In this embodiment, the light-emitting device 1 is formed as a planar light emitting illumination lamp, and the region where the excitation surface of the phosphor layer 7 is projected to the glass substrate 2 forms a substantial light projection window that irradiates light towards the outside.

In addition, a reflective surface (optical reflective surface) 5a is also disposed on the surface of the anode electrode 5 where the phosphor layer 7 is formed for the purpose of reflecting light escaping from the rear surface of the excitation surface (electron incidence plane) of the phosphor layer 7. This reflective surface 5a is formed by, for example, forming an aluminum vapor deposition film on the anode electrode 5 or making the electrode surface of the anode electrode 5 into a mirror finished surface.

Because of this, the intense light emitted from the excitation surface of the phosphor layer 7 emitted toward the glass substrate 2 passes through the glass substrate 2 and then is directly emitted towards the outside without hindrance. In addition, the light escaping to the side opposite the excitation surface of the phosphor layer 7 is reflected by the reflective surface 5a of the anode electrode 5 and then emitted from the glass substrate 2. As a result, an extremely efficient fully reflective light-emitting device can be realized compared to a conventional light-emitting device.

In other words, the construction in a conventional light-emitting device that has a plane-shaped light-emitting surface is such that the phosphor layer is formed on the inner surface of the glass substrate, that forms the light projection window and when an electron beam irradiates the phosphor layer inside the vacuum chamber, the excitation light transmits from the rear (side opposite the irradiation surface of the electron beam) of the phosphor film through the glass substrate and is radiated towards the outside.

Therefore, the construction in a conventional light-emitting device is such that even though the excitation surface of the phosphor that is irradiated by the electron beam has the most intense emitted light, the light from the excitation surface (electron incident plane) is emitted towards the inside of the vacuum chamber without being emitted towards the outside and is then absorbed as wasted emitted light on a black cathode film surface whose principal component is, for example, carbon.

In contrast to this, the light-emitting device according to the present invention has a construction in which light emitted from the excitation surface of the phosphor layer 7 that is irradiated by the electron beam and thus has the most intense emitted light, and also the light reflected by the reflective surface 5a on the rear surface of the excitation surface are both emitted from the light projection window (glass substrate 2) towards the outside thereby greatly increasing the quantity of light radiated towards the outside compared to a conventional device.

In more detail, the electron beam irradiated towards the phosphor layer 7 is controlled by means of the cathode electrode 6 disposed outside the light path towards the light projection window of the light emitted by the phosphor layer 7, the electron emission source 8 formed on the cathode electrode 6, and the gate electrode placed above the electron emission source 8 (glass substrate 8 side). In this example, the electron emission source 8 is a cold cathode electron emission source that emits electrons in a vacuum from a solid surface through the application of an electric field and is formed by applying an emitter material of, for example, CNT (carbon nanotube), CNW (carbon nanowell), Spindt type micro cone, or metallic oxide whiskers onto the cathode electrode 6 in a film state.

A thermal electron emission source that is a combination of an emitter material that emits thermal electrons such as barium oxide and a heater can also be used in place of the cold cathode type electron emission source 8.

In addition, the gate electrode 9 controls the electrical potential difference with the cathode electrode 6 and deflects and controls the electron beam emitted upward from the electron emission source 8, to make the beam fall onto the phosphor layer 7 tracing an approximate parabola. This gate electrode 9 is a flat type electrode that has apertures 10 to allow electrons emitted from the electron emission source 8 to pass through and is formed using a conductive metallic material such as a nickel material, a stainless steel material, or an umber material through a simple mechanical process, such as etching, or screen printing.

Although the apertures 10 of the gate electrode 9 are formed as a plurality of round holes arranged in two rows along the lengthwise direction of a rectangular region in FIG. 2, their shapes should be appropriately set so that the electron beam emitted from the electron emission source 8 uniformly irradiates the entire surface of the phosphor layer 7, taking into consideration the electric field strength applied to the electron emission source 8 and the distance between the electron emission source 8 and the phosphor layer 7. Even further, a cathode mask 11 is disposed over the electron emission source 8. This cathode mask 11 has apertures which correspond to the plurality of round holes which form the apertures 10 of the gate electrode 9. The cathode mask 11 is formed from a conductive material and is normally maintained at the same electric potential as the cathode electrode 6.

Hereupon, although only the electrons which pass through the apertures 10 of the gate electrode 9 among the electrodes emitted by the electric field in a vacuum from the electron emission source 8 are effective electrons which bombard the phosphor layer 7 and release light, a portion of the electrons are absorbed on the non-opening surface of the gate electrode 9 and become ineffective electrons resulting in a power loss. The cathode mask 11 reduces the power loss of the gate electrode 9 due to these ineffective electrons and is formed as a member almost the same shape as the gate electrode 9. And as shown in FIG. 3, the apertures 12 of the cathode mask 11 and the apertures 10 of the gate electrode 9 cover the electron emission source 8 as an almost identical shape (similar shape).

In other words, it is possible to form the regions where electrons are emitted from the electron emission source 8 into regions almost identical to the open regions of the gate electrode 9 and allow almost all electrons emitted from these regions to pass through the apertures 10 of the gate electrode 9, producing effective electrons which contribute to the emission of light by means of covering the electron emission source 8 using the cathode mask 11 that has open regions almost identical to the open regions of the gate electrode 9. Because of this, power loss of the gate electrode 9 can be reduced allowing a lossless gate to be realized.

In order to realize this lossless gate effectively, the opposing distance between the gate electrode 9 and the cathode mask 11 as well as the relationship of the aperture diameter must be suitably set. At first, the opposing distance S between the gate electrode 9 and the cathode mask 11 is set to a prescribed lower limit value or higher. This lower limit value is set to a distance that can prevent the occurrence of harmful metal sputter from the gate electrode 9 to the cathode electrode 6 while at the same time a distance that excludes the distance between the gate electrode 9 and the cathode mask 11 from being too close for effectively generating an electric field and significantly reducing the electrons emitted from the electron emission source 8. An example of such distance could be S>=0.5 mm.

In the relationship between the apertures 10 of the gate electrode 9 and the apertures 12 of the cathode mask 11, if the respective aperture dimensions are AG and AM, respectively, the aperture dimensions AG of the apertures 10 of the gate electrode 9 are preferably within a range established while taking into consideration the electric field strength required to emit light on the phosphor layer 7 and alignment errors between the gate electrode 9 and the cathode mask 11 as compared to aperture dimensions AM of the apertures 12 of the cathode mask 11.

The aperture dimensions here refer to the dimensions at corresponding positions of the apertures 10 and 12 which are similar to each other. When an aperture is a round hole, the aperture dimension is its diameter (or radius), and when the aperture is rectangular-shaped, the distance will be between the long sides or the short sides of the rectangular in each rectangular shape. It is the same with other shapes.

For example, when the thickness of the entire panel of the light-emitting device 1 is 5 mm or less and the aperture dimensions AM of the apertures 12 of the cathode mask 11 are AM=0.5 mm to 5 mm, the opposing distance S between the gate electrode 9 and the cathode mask 11 should preferably satisfy the conditions shown in equation (1) below. In addition, the aperture dimensions AG of the apertures 10 of the gate electrode 9 should preferably satisfy the conditions shown in equation (2) below with respect to the aperture dimensions AM of the apertures 12 of the cathode mask 11.

0.5 mm<=S<5 mm (1)

AM<=AG<=AM+0.5 mm (2)

The arrangement pitch P of the apertures 10 (12) fundamentally depend on the process capacity during manufacturing. For example, P>=AG+d (d: plate thickness of the processed material).

Because of this, it is possible to prevent concentration of an electric field towards the periphery of the electron emission source 8 and prevent electrons emitted from the electron emission source 8 from rushing towards the gate electrode 9, thus reliably preventing the occurrence of metallic sputtering. In addition to this, it is also possible to allow almost all electrons emitted from the electron emission source 8 to pass through the apertures 10 of the gate electrode 9 and reach the phosphor layer 7 of the anode electrode 5 as effective electrons which contribute to the emission of light, thereby effectively reducing the power loss at the gate electrode 9.

By means of forming the cathode electrode 6 together with the electron emission source 8 in a pattern corresponding to the apertures 10 of the gate electrode 9 such that the electrode surface is not exposed, the cathode mask can be omitted.

Next, the operation of the light-emitting device 1 in the embodiment will be described. When operating the light-emitting device 1, the anode electrode 5 is maintained at a high electrical potential with respect to the cathode electrode 6 and the gate electrode 9. A gate voltage, having a higher electrical potential with respect to the cathode electrode 6, is applied to the gate electrode 9. In other words, when an electric field is applied to the electron emission source 8 and the electric field concentrates on the solid surface that forms the electron emission source 8, the electrons will be released from the solid surface into vacuum, the electrons emitted by this electric field will be accelerated towards the gate electrode 9 and almost all the electrons will pass through the apertures 10 and be emitted upward (glass substrate 2 side).

The gate voltage obtained by the gate electrode 9 is controlled to be a voltage such that the electron beam passing through the apertures 10 deflect from an upward facing direction and uniformly fall onto the phosphor layer 7 in a parabolic shape. The phosphor layer 7 is excited and emits light by means of this electron beam irradiating the phosphor layer 7. Because only a vacuum space lies between the excitation surface (electron beam irradiation surface) of the phosphor layer 7 and the glass substrate 2 that forms the light projection window and nothing exists that can interfere, the intense light emitted by the excitation surface of the phosphor layer 7 transmits through the glass substrate 2 and is emitted towards the outside without any interference.

At this time, light passing through the granular layer of the phosphor layer 7 towards the lower surface and light excited and emitted on the lower surface of the granular layer is reflected by the reflective surface 5a formed on the anode electrode 5 and then emitted towards the light projection window (glass substrate 2). Consequently, almost all the light excited and emitted by the phosphor layer 7 transmits through the glass substrate 2 and is emitted towards the outside thereby making it possible to suppress the electric power consumption and significantly increase the quantity of light compared to a conventional light-emitting device.

Thus, because the excitation surface of the phosphor layer 7 that is irradiated by the electron beam and emits light is arranged, in this embodiment, directly opposite the glass substrate 2 that forms the light projection window, while the cathode electrode 6, the electron emission source 8, and the gate electrode 9 are arranged outside the light path towards the light projection window of the light emitted by the phosphor layer 7, only a vacuum space lies between the phosphor layer 7 and the glass substrate 2. Consequently, almost all the light emitted by the phosphor layer 7 transmits through the light projection window of the glass substrate 2 and is emitted towards the outside without any interference. Because of this, excitation light from the phosphor being wastefully emitted inside the device is eliminated, making it possible to improve the luminous efficiency and significantly increase the quantity of light emitted from the entire light projection window towards the outside compared to a conventional light-emitting device.

For this case, the arrangement of the cathode electrode 6 (and the electron emission source 8, and gate electrode 9) with respect to the phosphor layer 7 on the anode electrode 5 is not limited to the arrangement shown in FIG. 1 and FIG. 2 above. For example, as shown in FIG. 4 and FIG. 5, it can be set to an appropriate position outside the light path towards the light projection window between the phosphor layer 7 and the glass substrate 2.

FIG. 4 shows a second arrangement example, in which the cathode electrode 6, the electron emission source 8, and the gate electrode 9 are arranged in a long and narrow rectangular-shaped region at the approximate center of a glass substrate 3 that forms the base bottom surface of the vacuum chamber that forms the light-emitting device 1, and the anode electrode 5 and the phosphor layer 7 are arranged in a rectangular-shaped region on both sides of the electron emission source 8 in the center. In FIG. 4, the size of the region of the electron emission source 8, the shape and number of the apertures 10 of the gate electrode 9, and the gate voltage are suitably set so as to uniformly irradiate the electron beam emitted from the electron emission source 8 on both sides of the phosphor layer 7. The arrangement shown in FIG. 4 and the arrangement shown in FIG. 2 can be used as units to make several combinations.

FIG. 5 shows a third arrangement example in which the anode electrode 5 and the cathode electrode 6 are not arranged on the same plane, but the electron emission source 8 on the cathode electrode 6 is arranged slightly more upward (glass substrate 2 side) than the phosphor layer 7. In FIG. 5, although the electron emission source 8 on the cathode electrode 6 and the gate electrode 9 are slanted upward diagonally, the cathode electrode 6 (as well as the electron emission source 8, the gate electrode 9) is at a position where the direction normal to the electrode surface of the cathode electrode 6 does not intersect the phosphor layer 7. In other words, the cathode electrode 6 preferably stops at a position as far as the framing member 4 that forms the sidewall of the vacuum chamber. This also depends on the distance between the electron emission source 8 and the phosphor layer 7 as well as the electric field distribution applied to the electron emission source 8. However, in order to make the phosphor layer 7 uniformly emit light, the electron beam from the electron emission source 8 must not concentrate at the edges of the phosphor layer 7.

What is claimed is:

1. A light emitting device for emitting light toward the outside with a phosphor excited by an electron beam emitted from a electron emission source arranged inside a vacuum chamber,
said light emitting device comprising:
an anode electrode arranged opposite a transparent base material that forms a light projection window of said vacuum chamber,
a phosphor layer arranged on a surface of said anode electrode facing said transparent base material,
a cathode electrode arranged outside the light path in the direction of the light projection window of the light emitted by said phosphor layer,
an electron emission source arranged on said cathode electrode, and
a gate electrode that deflects and controls the electron beam emitted from said electron emission source to irradiate the surface of said phosphor layer facing said transparent base material.

2. A light emitting device as in claim 1, wherein the surface of said anode electrode making contact with said phosphor layer is an optical reflective surface polished to a mirror finish.

3. A light emitting device as in claim 1, wherein said cathode electrode is arranged at a position outside the light path towards said light projection window, between said phosphor layer and said transparent base material.

4. A light emitting device as in claim 1, wherein said cathode electrode is arranged in a position such that a direction normal to the electrode plane does not intersect said phosphor layer.

5. A light emitting device as in claim 1, wherein said anode electrode and said cathode electrode is provided on an insulation base material that forms a same plane facing said transparent base material.

6. A light emitting device as in claim 1, wherein
said electron emission source is formed as a cold cathode electron emission source that emits an electron beam through an application of an electric field,
said gate electrode is provided with an aperture through which the electron beam from said cold cathode electron emission source passes through, and
said cold-cathode electron emission source is covered by a cathode mask having an aperture approximately identical to said aperture of said gate electrode.
